(19) United States
(12) Patent Application Publication
(10) Pub. No.: US 2011/0310829 A1
(43) Pub. Date: Dec. 22, 2011

(54) METHOD AND APPARATUS FOR GROUPING CONTROL CHANNEL RESOURCE IN MOBILE COMMUNICATION SYSTEM

(75) Inventors: Hyoung Ju Ji, Seoul (KR); Joon Young Cho, Suwon-si (KR); Jin-Kyu Han, Seoul (KR)

(73) Assignee: Samsung Electronics Co., Ltd., Suwon-si (KR)

(21) Appl. No.: 13/164,170

(22) Filed: Jun. 20, 2011

(30) Foreign Application Priority Data
Jun. 18, 2010 (KR) 10-2010-0058189

(51) Int. Cl. H04W 72/04

(52) U.S. Cl. 370/329

(57) ABSTRACT

A method for grouping a control channel resource in an Orthogonal Frequency Division Multiplexing based mobile communication system for adjusting inter-cell interference and an apparatus performing the same are disclosed. Inter-cell inference used between cells or base stations is controlled or distributed to secure reception of a control channel in a heterogeneous system, and interference may be efficiently controlled through coordination of resource groups by cells. The method and apparatus are equally applicable when resources of backhaul transmission channel of a relay cell in a cell are grouped.

### PRIORITY

This application claims priority under 35 U.S.C. 119(a) to an application filed in the Korean Intellectual Property Office on Jun. 18, 2010, and assigned Serial No. 10-2010-0058189, the contents of which are incorporated herein by reference.

### BACKGROUND OF THE INVENTION

1. Field of the Invention

The present invention generally relates to a method for grouping a control channel resource in a mobile communication system and an apparatus for performing the same, and more particularly, to a method for grouping a control channel resource in an Orthogonal Frequency Division Multiplexing (OFDM) communication heterogeneous system among mobile communication systems, and an apparatus for performing the same.

2. Description of the Related Art

In general, a mobile communication system has been developed to provide an audio service while securing activity of a user. With the development of communication technology, mobile communication systems have expanded to data services, including audio services. Current mobile communication systems have also been developed to provide high speed data services.

An OFDM transmission scheme is a scheme that transmits data using a digital multi-carrier modulation method. In detail, the OFDM transmission scheme is a multi carrier modulation scheme that converts input serial symbol rows into parallel symbol rows, for modulation and transmission via a plurality of multi carriers having mutual orthogonal relation.

A system adopting the multi carrier modulation scheme was initially applied to an army high frequency radio in the 1950's. Development of an OFMD scheme overlapping a plurality of orthogonal sub carriers started in the 1990's. However, since the OFDM scheme has a difficulty in implementing an orthogonal modulation between multi carriers, there is limited application in real systems. However, as Weinstein, et al. developed a processing scheme using a Discrete Fourier Transform (DFT) being modulation and demodulation schemes using the OFDM scheme, an OFDM scheme technology has rapidly been developed.

Further, as a scheme inserting a Cyclic Prefix (CP) in a guard interval using the guard interval is known, a negative influence of a system with respect to multiple path and delay spread is further reduced. The OFDM scheme has not widely used due to hardware complexity. However, in recent years, various types of digital signal processing technology, including Fast Fourier Transform (FFT) and Inverse Fast Fourier Transform (IFFT), have been developed to implement the OFDM scheme.

With the development of the technology, the OFDM scheme has widely been applied to digital transmission technology such as Digital Audio Broadcasting (DAB), Digital Video Broadcasting (DVB), Wireless Local Area Network (WLAN), and Wireless Asynchronous Transfer Mode (WATM).

The OFDM scheme is similar to a conventional Frequency Division Multiplexing (FDM). However, first of all, the OFDM scheme may maintain orthogonality between a plurality of tones to obtain optimal transmission efficiency and transmission of high speed data. Further, since the OFDM scheme has excellent efficiency of frequency use and is robust to multi-path fading, it may obtain optimal transmission efficiency upon transmission of high speed data.

Other merits of the OFDM scheme are as follows. Because the OFDM scheme overlaps and uses a frequency spectrum, frequency use is efficient. Further, the OFDM scheme is robust to frequency selective fading and multi-path fading. The OFDM scheme may reduce Inter Symbol Interference (ISI) influence using a guard interval. The OFDM scheme may simply design a hardware equalizer structure. In addition, since the OFDM scheme is robust to an impulse noise, it tends to be actively used to a communication system structure.

An impeding factor to high speed and high quality data service generally is a channel environment. The channel environment in the wireless communication system frequently changes due to power variation and shadowing of a received signal caused by fading, a Doppler effect according to movement and frequent speed change of a UE, and interference from other users and a multi-path signal, as well as Additive White Gaussian Noise (AWGN). Accordingly, to support a data service of high speed and quality in the wireless communication system, there is a need to efficiently overcome the foregoing impeding factors of a channel environment.

A modulation signal in an OFDM scheme is located at a two-dimensional resource composed of time and frequency. Further, the time resource includes different OFDM symbols, which are orthogonal to each other. The frequency resource includes different tones, which are orthogonal to each other. Consequently, if a certain OFDM symbol is designated based on a time axis and a certain tone is designated based on a frequency axis in the OFDM scheme, it may indicate one minimal unit resource. This refers to a Resource Element (RE). Although different REs pass through a frequency selective channel, they are orthogonal to each other. Accordingly, signals transmitted to different REs do not cause mutual interference but may be received to a receiving side.

A physical channel is a channel of a physical layer transmitting a modulation symbol that modulates one or more encoded bit rows. An Orthogonal Frequency Division Multiple Access (OFDMA) system transmits a plurality of physical channels according to application of information rows to be transmitted or received. A transmitter and a receiver will previously mutually agree which RE one physical channel is to be disposed when it is transmitted, which is a rule called photographing or mapping.

However, in current mobile communication systems there is a need for an improved mobile communication system due to a lack of resources when users request a greater amount of service.

To meet the requirements, a standard work for a Long Term Evolutions (LTEs) in the 3rd Generation Partnership Project (3GPP) being developed is advanced as a next generation mobile communication system. With a goal of commercializing LTEs in 2010, technology implementing high speed packet based communication having transmission speed of approximately maximum 100 Mbps is expected to be commonly used in 2010. To do this, an approach simplifying a structure of a network to reduce the number of nodes located on a communication line or an approach approaching wireless protocols to a wireless channel to the highest degree has been discussed.

Here, an LTE-Advanced system is a system expanding an LTE system to which a new technology is added to support a heterogeneous cell structure. Inter-channel interference being one of the greatest problems in a heterogeneous system is a significant problem in a control channel of an LTE system. Interference of a data channel may be adjusted by coordination between cells. However, inter-cell interference may not be adjusted due to structural problem where a control channel is distributed over all bands during transmission. Accordingly, there is a need for a new control channel design.

### SUMMARY OF THE INVENTION

The present invention has been made in view of the above problems and provides a method for grouping a control channel resource for efficiently adjusting interference in an OFDM heterogeneous system that enables a new control channel multiplexed with a data channel to adjust interference through efficient coordination between cells and to efficiently distribute inter-cell interference of a new control cell, and an apparatus thereof.

An aspect of the present invention is to address at least the above-mentioned problems and/or disadvantages and to provide at least the advantages described below.

In accordance with an aspect of the present invention, a method for grouping a control channel resource of a base station is provided. The method includes grouping a physical resource block to which the control channel resource will be mapped in a data channel region; determining a group to be used by a user equipment among groups of the physical resource blocks and transmitting the information about the group through upper signaling; and mapping the control channel resource to the determined group and transmitting the mapped result to the user equipment.

In accordance with an aspect of the present invention, a mobile communication system for grouping a control channel resource is provided, the system including a base station grouping a physical resource block to which a control channel resource will be mapped in a data channel region to determine a group to be used by a user equipment from groups of the physical resource block, transmitting information about the group to the user equipment through upper signaling, mapping the control channel resource to the group, and transmitting the mapped result to the user equipment; and the user equipment receiving a physical resource block index to be used by the user equipment from a group allotted according to group information of a physical resource block to which the control channel is mapped when the group information is received through upper signaling, and demodulating scheduling information from a control channel resource corresponding to the physical resource block index.

### BRIEF DESCRIPTION OF THE DRAWINGS

The objects, features and advantages of the present invention will be more apparent from the following detailed description in conjunction with the accompanying drawings, in which:

FIG. 1 illustrates an arrangement of a base station in a heterogeneous system according to an embodiment of the present invention;

FIG. 2 illustrates a control channel structure in an OFDM system according to an embodiment of the present invention;

FIG. 3 illustrates a configuration order of a control channel applied to the present invention;

FIG. 4 illustrates a grouping structure of a control channel resource according to a first embodiment of the present invention;

FIG. 5 illustrates a grouping structure of a control channel resource according to a second embodiment of the present invention;

FIG. 6 illustrates a grouping structure of a control channel resource according to a third embodiment of the present invention;

FIG. 7 is a flowchart illustrating a method for grouping a control channel resource by a base station according to an embodiment of the present invention;

FIG. 8 is a flowchart illustrating a method for grouping a control channel resource by a UE according to an embodiment of the present invention;

FIG. 9 is a block diagram illustrating a base station for grouping a control channel resource according to an embodiment of the present invention; and

FIG. 10 is a block diagram illustrating a UE for grouping a control channel resource according to an embodiment of the present invention.

### DETAILED DESCRIPTION OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but are merely used by the inventor to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

Hereinafter, an LTE system and an LTE-Advanced system are described in the specification by way of example. However, the present invention is applicable to other wireless communication systems to which a control channel resource allotment scheme is applied.

An LTE system is a system in which an OFDM scheme is applied to a downlink and a Single Carrier-Frequency Division Multiple Access (SC-FDMA) is applied to an uplink. Further, the LTE-Advanced (LTE-A) system is a system in which an LTE system is expanded and configured to a multi band, and a relay is applied to the LTE-A system.

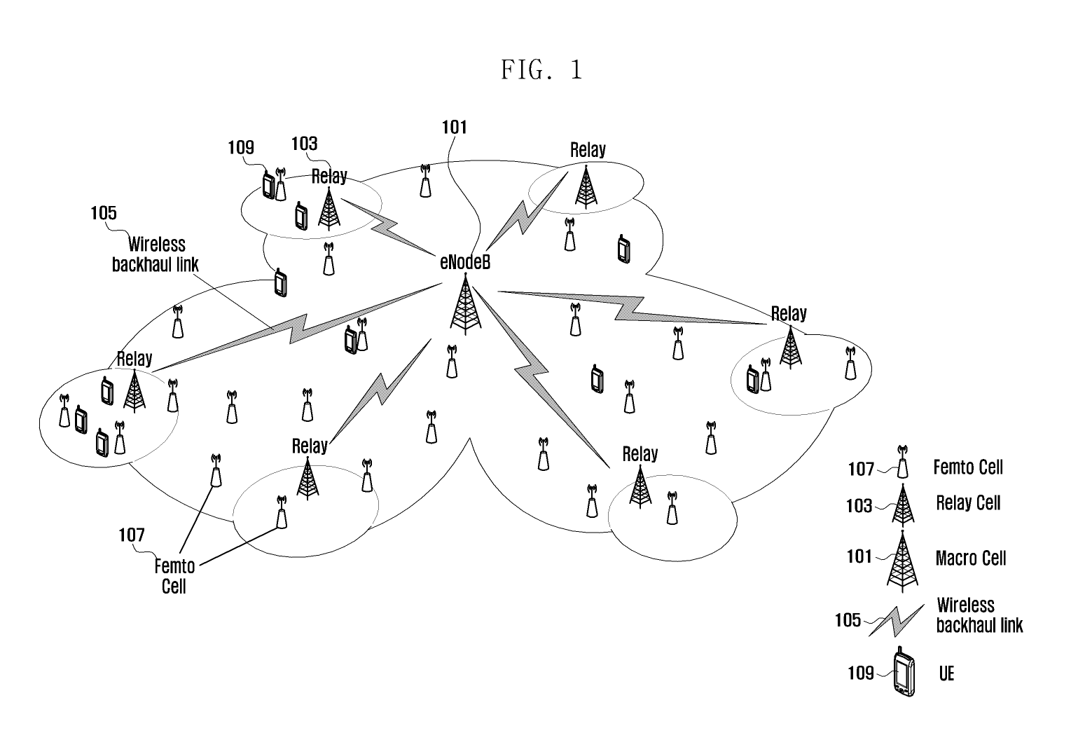

FIG. 1 illustrates an arrangement of a base station in a LTE-A heterogeneous system according to an embodiment of the present invention.

Referring to FIG. 1, one base station (eNodeB) 101 has at least three cells, and small cells overlap with each other under one macro cell 101 in a heterogeneous cell structure. Here, a small cell includes a relay cell 103 and a Femto cell 107.

The relay cell 103 is a system that has the same structure and environment as those of an existing cell and uses a wireless backhaul link 105. As shown in FIG. 1, it may be appreciated that two or more relay cells 103 may be included in one large macro cell 101.

The Femto cell 107 is a representative cell of the heterogeneous cell, and provides service to small indoor zone. Although the cell size of the Femto cell 107 is very small, several tens or hundreds Femto cells may be overlapped in the large macro cell. Consequently, when there is one macro cell in the same zone in a communication system configured by the heterogeneous cell, the number of Femto cells will significantly increase in comparison with that of the macro cells.

Increasing the number of the Femto cells 107 of the relay cells 103 increases interference power per zone and reduces a cell radius. Inference applied to the control channel will also increase, as compared to interference where only an existing macro cell is present. In particular, when a macro cell User Equipment (UE) 109 passes through a Femto cell 107 zone, large interference is applied thereto. Inter-backhaul link interference may occur in the relay cell 103. Because the backhaul link is a wireless type in the relay cell 103, error occurs due to interference that deteriorates the entire performance of the system. Thus, the eNodeB should secure a channel having the best performance.

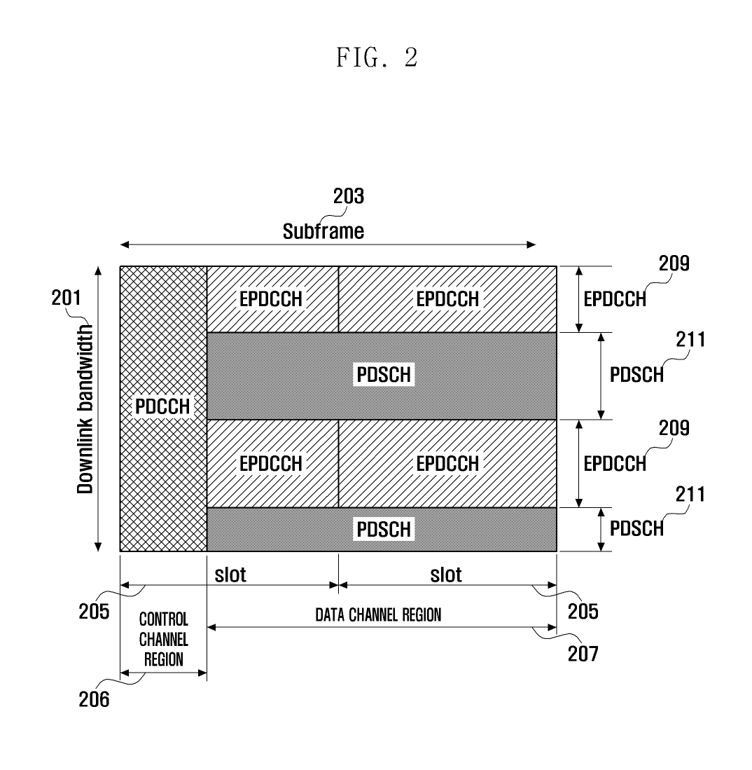

FIG. 2 illustrates a control channel structure in an OFDM system according to an embodiment of the present invention.

Referring to FIG. 2, an entire LTE transmission bandwidth 201 consists of a plurality of Resource Blocks (RBs). Each of the RBs is composed of twelve tones arranged on a frequency axis, and twelve or fourteen OFDM symbols each RB becomes a fundamental unit of resource allotment. The entire LTE transmission is for uplink as well as for downlink. However, the entire LTE transmission is for downlink in this case.

One sub frame 203 has a length of 1 ms, which is composed of two slots 205. When the RB is composed of fourteen OFDM symbols, the sub frame refers to a Normal CP sub frame structure. When the RB is composed of twelve OFDM symbols, the sub frame refers to an Extended CP sub frame structure.

A physical channel of the LTE system is divided into a control channel region 206 and a data channel region 207. The control channel region 206 is located at a front part of the data channel region 207 on a time scale. The data channel region 207 is located after the control channel region 206, and is allotted for each Physical Resource Block (PRB). The control channel region 206 is a region to which a Physical Downlink Control Channel (PDCCH) is mapped. The data channel region 207 is a region to which a Physical Downlink Shared Channel (PDSCH) is mapped.

Further, an Evolved Physical Downlink Control (EPDCCH) 209 is frequency multiplexed with the data channel (PDSCH) 211 to be transmitted. That is, the EPDCCH 209 is mapped to the data channel region 207 together with the PDSCH 211 using a resource classified based on a frequency axis.

The reason to locate the control channel region at top of the sub frame is that a UE firstly receives a PDCCH allotted to the control channel region 206 to recognize the presence of transmission of the PDSCH. Once the presence of transmission of the PDSCH is recognized, the UE may determine whether to perform a receiving operation of the PDSCH.

If no PDSCH transmitted to the UE, it is unnecessary to receive the PDSCH mapped to the data channel region 207. Accordingly, the UE may save power consumed in a receiving operation of the PDSCH. Meanwhile, the UE may receive a PDCCH located at the control channel region faster than the PDSCH 211 to reduce a scheduling relay. However, because the PDCCH is transmitted over an entire band in a structure, interference control is impossible.

The control channel region 206 may not be changed to a frequency multiplexing structure to maintain compatibility with an existing UE. However, if the eNodeB does not allot a corresponding region of the data channel region 207 to a UE of a previous version, the UE of a previous version does not receive a resource mapped to a corresponding data channel region 207. Accordingly, the eNodeB may transmit an EPDCCH 209 for a UE of a new version to a data channel region 207 that is not allotted to the UE. In other words, an EPDCCH being a PDDCH for a UE of a new version has a structure multiplexed with the PDSCH.

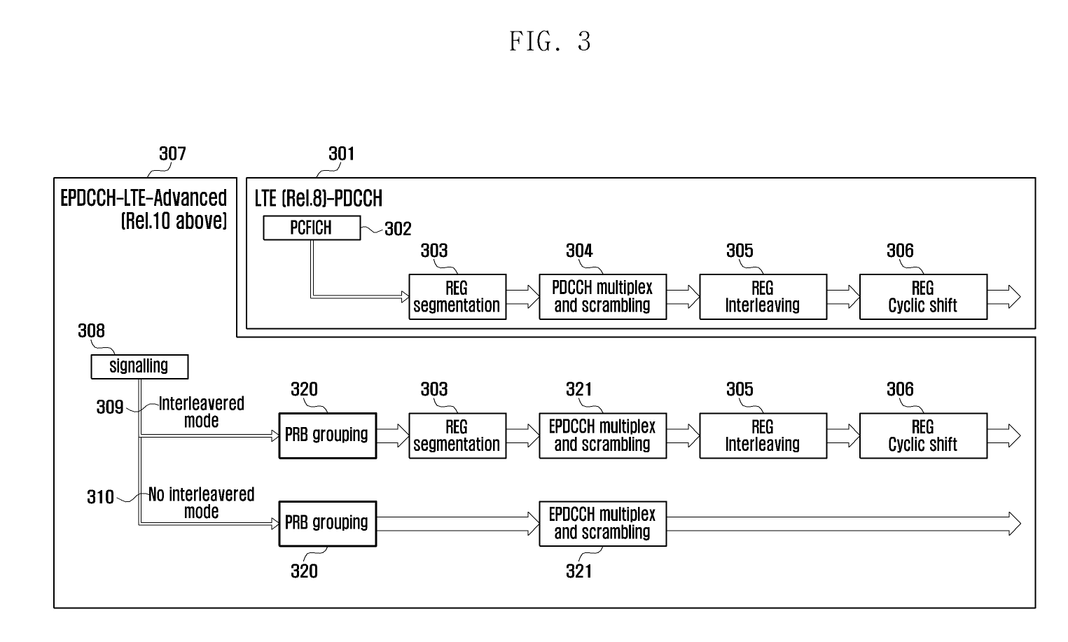

FIG. 3 illustrates a conventional method for transmitting a control channel and a method for transmitting a new control channel. The conventional method for transmitting a control channel is described with reference to reference numeral 301 of FIG. 3.

First, the eNodeB informs a Physical Control Indicator Channel (PCFICH) 302 of a total amount of a PDCCH resource. Here, in step 302 the PCFICH includes information indicating the number of symbols to be used in the PDCCH. The eNodeB segments a Resource Element Group (REG) resource in step 303 in units of four continuous REs of entire resources. Next, the eNodeB allots a PDCCH to be currently transmitted to a location agreed with each UE, and performs scrambling in step 304 using a unique cell sequence.

Subsequently, the eNodeB interleaves respective PDCCHs in units of REGs to uniformly spread one PDCCH to entire control channel regions in a sub frame in step 305. At this time, because all cells use the same interleaver, when amounts of used PDCCHs are the same, when the PDCCHs are interleaved in units of REGs, the result is also the same. In order to distribute inter-cell interference, the eNodeB cyclically shifts the PDCCHs by a cell identification (ID) in units of REGs. Accordingly, the eNodeB may prevent inter-cell interference caused by using the same interleaver between cells, and REGs of a control channel allotted over one or plural symbols may acquire a diversity gain spaced apart from a frequency axis. Further, the eNodeB causes the REG constituting the same channel to be equally distributed between symbols by channels.

In the LTE system, Inter-Cell Interference Coordination (ICIC) is a technology for eNodeB control of inter-cell interference by sharing resource information used between cells. In detail, the eNodeB informs a neighboring cell of RB resource information transmitting higher power and RB resource information having interference sensed higher than a predetermined level among RB resources used in its cell. When receiving corresponding information, a cell adjusts transmission power and a scheduling method of an RB resource used by the cell based on the received information.

In a method for allotting a resource with respect to a data channel of an LTE system, one terminal is fundamentally allotted in units of RBs. However, a control channel is transmitted to one UE over an entire channel. Further, since an allotment unit of the control channel is an REG, the ICIC is not applicable to the control channel. However, in an LTE-A system, because an additional control channel may be configured, it is possible to design a control channel in which an ICIC is considered. In this case, so as to adjust inter-cell interference to transmit the control channel, PRB resource information used between cells should be exchanged.

The PRB resource used between the cells continuously changes in units of sub-frames. Further, the amount of resources necessary to transmit the control channel continuously changes. In other words, although a resource is previously allotted, a different amount of the resource is actually used. Accordingly, it is necessary to use an unused resource at another place. However, a resource use configuration with respect to a determined resource may not be changed within a short time through coordination between cells. Therefore, there is a need for a method of efficiently using a resource in a semi-static resource. To do this, the present invention efficiently manages an inter-cell resource through resource grouping and distributed interference to receive a control channel.

Reference numeral 307 of FIG. 3 shows a method for configuring a control channel multiplexed at a data channel region according to an embodiment of the present invention.

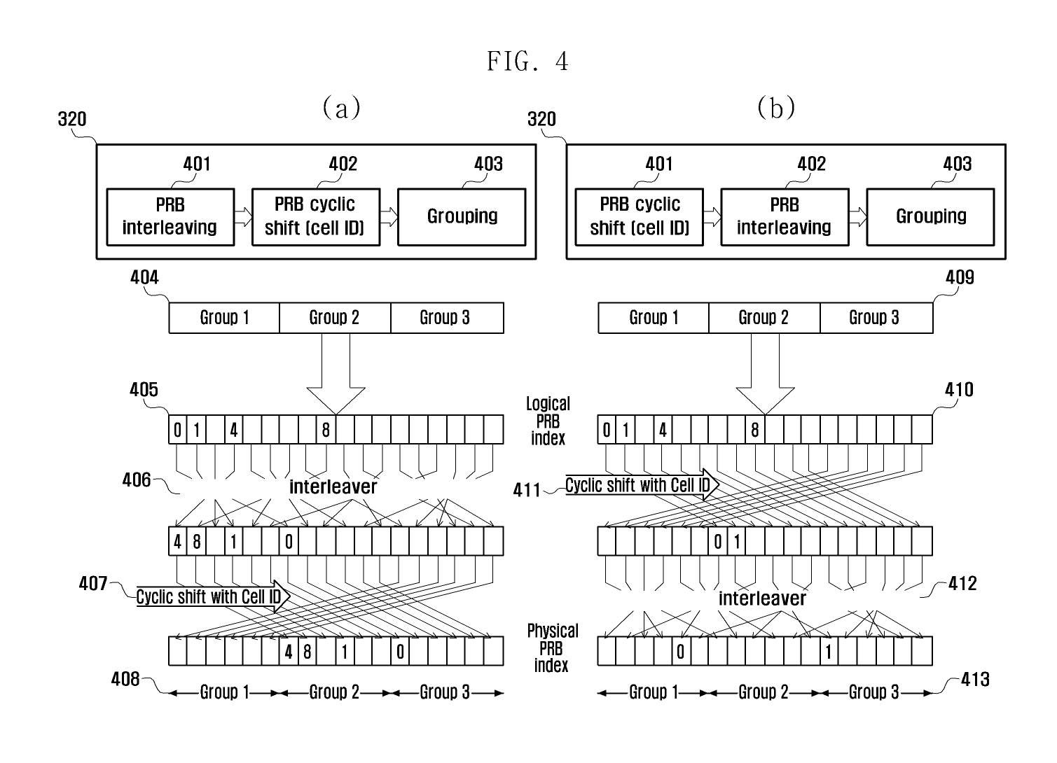

In step 308, information about a resource to which an EPDCCH being a newly defined control channel is allotted is transferred to a UE through upper signaling instead of the physical channel. At this time, an eNodeB informs the UE of presence of use of an interleaving mode in steps 309 and 310). The reason to inform presence of use of the interleaving mode by the eNodeB is that a UE using a UE common reference signal allows interleaving between different EPDCCHs but a UE using a UE dedicated reference signal does not allow interleaving between different EPDCCHs. In the present invention, the eNodeB allots a resource through upper signaling regardless of an interleaving mode to allot an EPDCCH and interprets the allotted resource. This procedure is a PRB grouping shown in step 320. Here, a grouping method of step 320 will be described with reference to FIG. 4 to FIG. 6 below.

A procedure allotting an REG is performed in the same manner as that described in regard to step 301 of FIG. 3. When interleaving is not additionally allowed between different EPDCCHs, REG unit operations of steps 303, 305, and 306 described at step 301 of FIG. 3 are all omitted.

FIG. 4 illustrates a grouping structure of a control channel resource according to a first embodiment of the present invention.

The first embodiment is a grouping method using an interleaver of a public PRB unit between cells and cyclic shift based on a cell ID. The method randomly allocates PRB index to groups within different cells but having the same group index. When coordination between cells is impossible because there are very many cells between heterogeneous cells, each resource group may use a random resource to distribute interference. Furthermore, an eNodeB may freely select a resource without coordination between cells. The size of the group is a PRB unit, and enables both a method using a fixed value and a method informing a UE of upper signaling according to a bandwidth for downlink.

A grouping method being step 320 of FIG. 3 using an interleaver of a public PRB unit between cells and cyclic shift based on a cell ID may be performed as shown in FIG. 4(a) and FIG. 4(b). First, referring to FIG. 4(a), an eNodeB performs an interleaving of a PRB unit such as a sub block 401 of the PRB grouping. Further, the eNodeB cyclically shifts an interleaving result by a cell ID in step 402. Finally, the eNodeB groups a PRB index from the greatest value to the least value according to a determined size in step 403.

Reference numerals 404˜408 in FIG. 4(a) illustrate a procedure for cyclic-shifting a PRB index after interleaving.

Assuming that there are three groups of PRBs and each group includes six PRBs in step 404, a logical PRB index in step 405 is interleaved in step 406, and the interleaved PRB index is cyclically shifted in step 407 together with a cell ID to be grouped in step 408. At this time, respective PRBs are grouped from a PRB having a lowest index value.

An execution order may substitute the interleaving procedure with a cyclic shift procedure, shown in steps 401 and 402 of FIG. 4(b). When the cyclic shift is performed, more random interleaving result between cells is obtained. In detail, steps 409-413 show an interleaving operation after cyclic shift.

In 409, there are three groups of PRBs and each group includes six PRBs. A logical PRB index at 410 is grouped through cyclic shift at 411 and interleaving procedure at 412. That is, a logical index of a PRB is converted to a physical index through interleaving and cyclic shift or through cyclic shift and interleaving procedure.

The first embodiment according to the present invention is a method allotting a resource using an interference distribution effect without coordination between cells. Exchange of group information between cells is needed for efficient interference distribution. However, in this embodiment, when a value is not exact and a delay is not exactly reflected, interference control of a similar level may be secured.

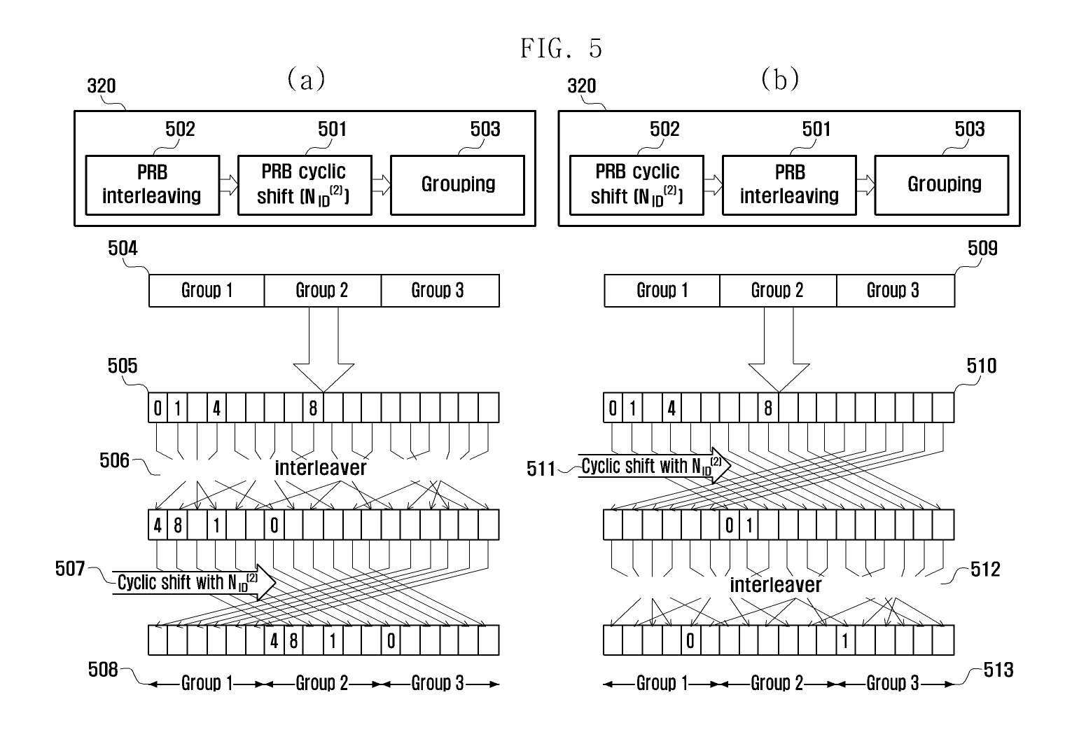

FIG. 5 illustrates a grouping structure of a control channel resource according to a second embodiment of the present invention.

The second embodiment is a grouping method using an interleaver of a public PRB unit between cells and a physical layer identity (referred to N_{ID}⁽²⁾′ hereinafter). The N_{ID}⁽²⁾ is one of two elements constituting a cell ID. In detail, one cell ID is composed of a physical layer cell-identity group (referred to N_{ID}⁽¹⁾′ hereinafter) and an N_{ID}⁽²⁾. The N_{ID}⁽¹⁾ is one of three IDs allotted to a macro cell. The N_{ID}⁽²⁾ is an ID allotted to a small cell and may have a number of values. Thus, small cells located in a macro cell receive allotment of one value of the N_{ID}⁽²⁾ and macro cells managed by the macro eNodeB divides three values of the N_{ID}⁽¹⁾.

It is assumed that a control channel is grouped based on the N_{ID}⁽²⁾. However, the present invention is not limited thereto. That is, a plurality of values constituting N_{ID}⁽²⁾ are divided into several groups, and PDCCHs may be cyclically shifted by groups. For example, if the N_{ID}⁽²⁾ is composed of 0 to 149, the PDCCHs are grouped in units of ten. The first embodiment described herein illustrates that the PDCCHs may be cyclically shifted using a grouped N_{ID}⁽²⁾ if a plurality of N_{ID}⁽²⁾ are grouped. However, the present invention is not limited thereto. Besides this, a plurality of cell IDs are grouped, and the PDCCH may be cyclically shifted through the grouped cell IDs. As a result, a cyclic shift method using a cell ID may include a method using respective cell IDs, a method using elements constituting the cell IDs, a method using grouped cell IDs, and a grouping and cyclic shifting method by a new definition.

The second embodiment described herein provides a method that, after grouping, results in the same value between cells and random values between base stations. Further, because there are a large number of cells between heterogeneous cells, coordination between cells in an eNodeB is easy. However, when coordination between base stations is difficult, respective groups between base stations may use a random resource to distribute interference. Because it is unnecessary to transfer a signal for coordination in the eNodeB, inference may be rapidly controlled. Since cells in the eNodeB are proximate to each other, they may use an orthogonal resource.

The second embodiment may use both an orthogonal resource in the eNodeB and a random interference distribution effect between base stations. The second embodiment has the same grouping procedure of a resource as that of the first embodiment. However, there is a difference between a cyclic shift value at step 402 of FIG. 4(a) and FIG. 4(b) and at step 502 of FIG. 5(a) and FIG. 5(b).

Referring to FIG. 5(a), after a logical PRB index at 505 passes through an interleaver at 506, it is cyclically shifted using the N_{ID}⁽²⁾ in at 507. Further, respective PRBs at 508 are grouped from a PRB having the lowest index value as illustrated in the first embodiment.

Referring to FIG. 5(b), reference numerals 509-512 show that cyclic shift is performed before interleaving. Accordingly, in this embodiment, base stations exchange a group index, a base station is optionally allotted between cells in the base station, and the base stations exchange group information used by all cells under the base stations. In this embodiment, when the number of cells under a base station increases, an amount of overhead of information exchange between cells may be reduced due to information exchange between base stations to efficiently control inference of an entire system.

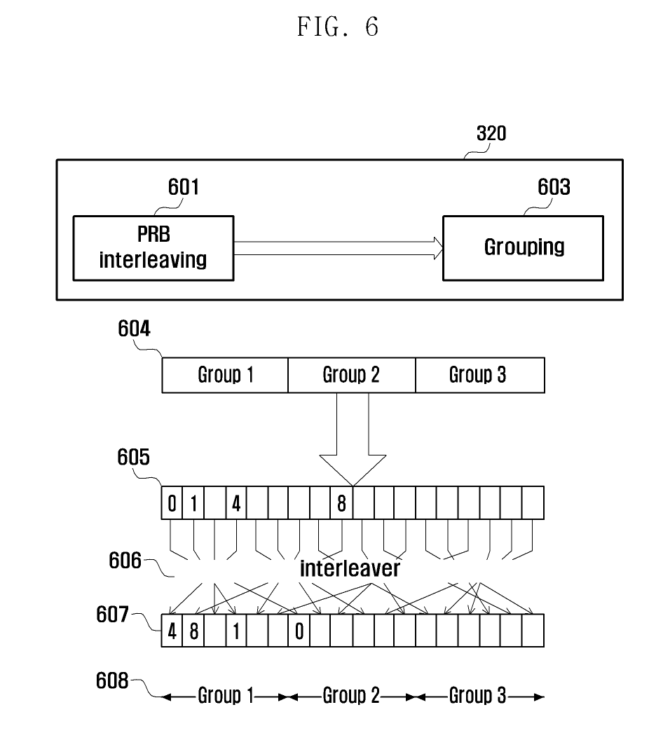

FIG. 6 illustrates a grouping structure of a control channel resource according to a third embodiment of the present invention.

The third embodiment is a grouping method using an interleaver of a public PRB unit between cells. Unlike the first and second embodiments, the third embodiment performs a common interleaver in step 601 between cells but does not perform cyclic shift. Through the third embodiment, results after grouping in step 603 are the same between cells and base stations. Further, the third embodiment may be used when there are a few cells between heterogeneous cells or a backhaul channel resource is divided by relay cells. Accordingly, relay cells in a base station may construct a backhaul resource by close coordination and secure a channel with high efficiency.

A grouping procedure of the third embodiment is identical to that of the first embodiment. The difference is that the third embodiment does not perform cyclic shift. If a group in 604 is determined, all cells convert a logical index in 605 into a physical index in 607 through one public interleaver in 606. Accordingly, only a group index is exchanged between cells, and the cells inform the UE of a group to be used by a corresponding UE from a group index used by each cell. Respective cells and UEs may extract a PRB index of respective groups in a method according to the present invention.

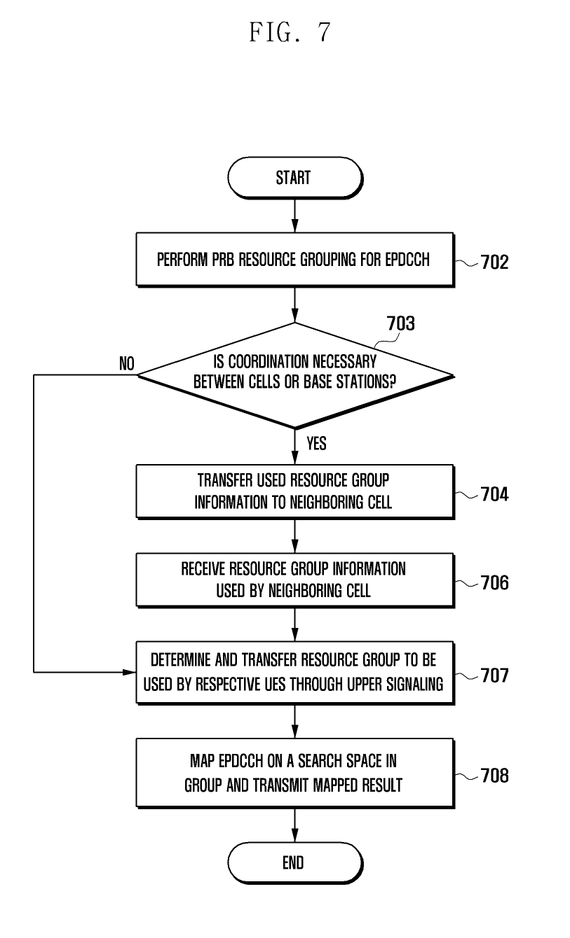

FIG. 7 is a flowchart illustrating a method for grouping a control channel resource by a base station according to an embodiment of the present invention.

Referring to FIG. 7, an eNodeB performs PRB resource grouping for an EPDCCH in step 702. Here, the EPDCCH indicates a PDCCH that may be allotted to only a UE of a new version. When in step 703 a determination is made that coordination of a resource group is necessary between cells or base stations, the base station transfers resource group information used by the base station to a neighboring cell in step 704. When coordination of the used resource group is determined not to be necessary between cells or base stations, the method proceeds to step 707.

After step 704, the base station receives resource group information used by a neighboring cell from the neighboring cell in step 706. After receiving the resource group information, the base station determines a resource group to be used by respective UEs, and transfers the determined group information to the receptive UEs through upper signaling in step 707. Subsequently, in step 708 the base station maps an EPDCCH on a search space in a group allotted to a UE for transmission of the EPDCCH and transmits the mapped result).

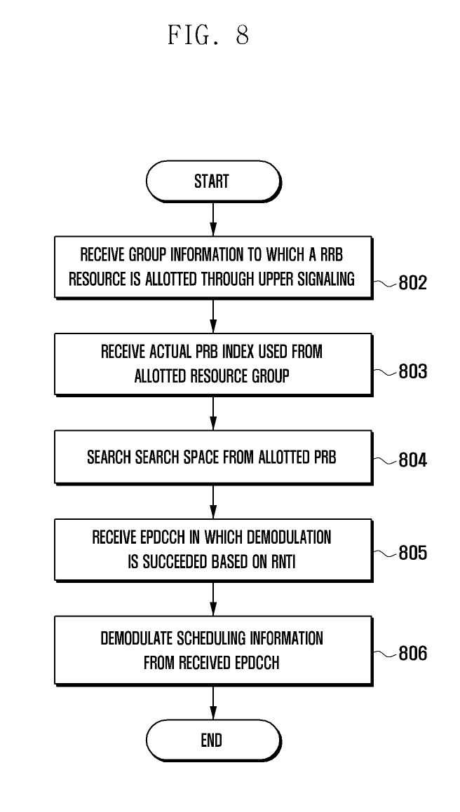

FIG. 8 is a flowchart illustrating a receiving method of a UE according to an embodiment of the present invention.

Referring to FIG. 8, a UE receives group information to which a PRB resource for an EPDCH is allotted through upper signaling in step 802. Next, the UE receives an actually used PRB index from a resource group allotted through the received group information according to a resource grouping rule in step 803. Subsequently, the UE searches a search space from the allotted PRB and demodulates its EPDCCH in step 804. The UE receives a demodulated EPDCCH based on its Radio Network Temporary Identifier (RNTI) in step 805. That is, the UE regards the demodulated EPDCCH as an EPDCCH transmitted thereto. Subsequently, the UE demodulates scheduling information from the received EPDCCH in step 806.

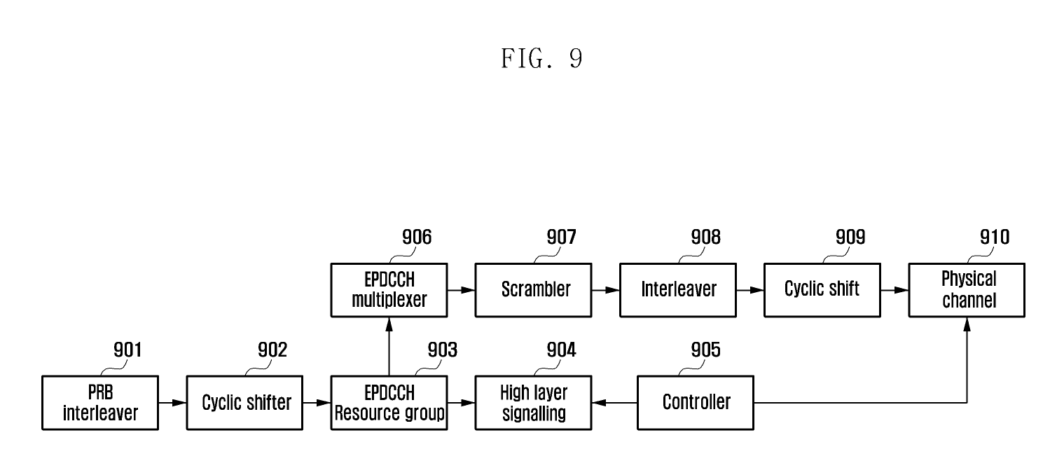

FIG. 9 is a block diagram illustrating components and operation of a base station according to an embodiment of the present invention.

Referring to FIG. 9, a base station constructs an EPDCCH resource group 903 for transmitting an EPDCCH using a PRB interleaver 901 and a PRB cyclic shifter 902. The base station transfers information about the EPDCCH resource group 903 to a UE through high layer or upper signaling 904. At this time, the base station controls the procedures by a controller 905 managing scheduling.

Further, the base station controls an EPDCCH multiplexer 906 to multiplex an EPDCCH of a UE using each resource group 903 through the controller 905, thereby constructing a resource. Next, the signal passes through a scrambler 907, a REG interleaver 908, and a REG cyclic shifter 909 in the same manner as for a conventional PDCCH, and multiplexes and transmits a PRB resource determined by the EPDCCH resource group 903 to the physical channel 910. Here, although not shown in drawings, the order of the PRB interleaver 901 and a cyclic shifter 902 may be changed so that interleaving is performed after the cyclic shifting.

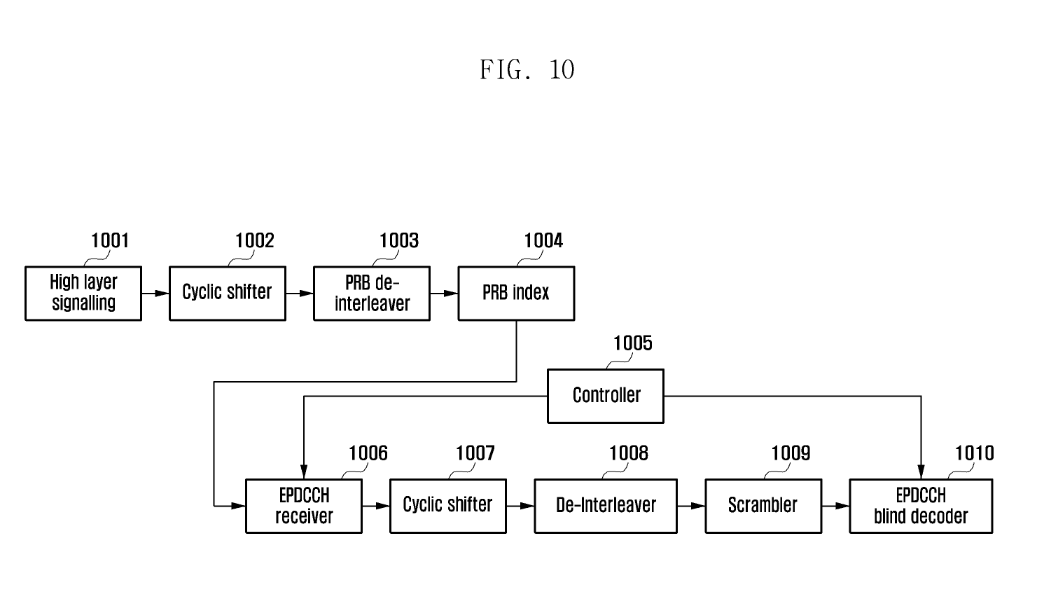

FIG. 10 is a block diagram illustrating a UE according to an embodiment of the present invention.

Referring to FIG. 10, a UE receives resource group information for receiving an EPDCCH through high layer or upper signaling 1001. Further, the UE extracts an actually used PRB index 1004 from a resource group allotted through the same cyclic shifter 1002 and PRB interleaver 1003 as those of the base station. At this time, a controller 1005 of the UE controls an EPDCCH receiver 1006 to try reception of an EPDCCH with respect to the extracted PRB index.

Next, the UE demodulates an entire resource of a received EPDCCH using cyclic shifter 1007, an REG reinterleaver 1008, and a scrambler 1009. Further, the UE demodulates an EPDCCH using a blind demodulator or decoder 1010 to search its EPDCCH in the received resource. As discussed above, the execution order of the cyclic shifter 1002 and a PRB interleaver 1003 may be changed. The execution order may be changed depending on whether to firstly perform cyclic shift or PRB interleaver before the base station groups the resource.

In the present invention, a control channel may be multiplexed with a data channel in an OFDM heterogeneous system of a mobile communication system, and efficient adjustment of inter-cell interference enables resource allotment. Interference between cells or base stations may be distributed through a grouped resource to receive a control channel with a small overhead. In addition, the present invention is equally applicable to a control channel of a UE being a receiver included in a heterogeneous cell and a relay.

While the invention has been shown and described with reference to certain embodiments thereof, it will be understood by those skilled in the art that various changes in form and details may be made therein without departing from the spirit and scope of the invention as defined in the appended claims and their equivalents.

What is claimed is:

1. A method for grouping a control channel resource of a base station, the method comprising:
grouping a physical resource block to which the control channel resource will be mapped in a data channel region;
determining a group to be used by a user equipment among groups of physical resource blocks and transmitting information about the determined group through upper signaling; and
mapping the control channel resource to the determined group and transmitting the mapped result to the user equipment.

2. The method of claim 1, wherein grouping a physical resource block comprises:
interleaving the physical resource block;
cyclically shifting the interleaved physical resource block by a cell identification (ID); and
grouping the cyclically shifted physical resource block in a physical resource block index order according to a predetermined group size.

3. The method of claim 2, wherein cyclically shifting the control channel resource uses a physical identity (N_{ID}⁽²⁾) being an ID allotted to a small cell among elements constituting the cell ID.

4. The method of claim 1, wherein transmitting the mapped result comprises transmitting resource group information used by the base station to a neighboring cell when coordination is necessary between cells.

5. The method of claim 1, wherein transmitting the mapped result comprises transmitting resource group information used by the base station to a neighboring cell when coordination is necessary between base stations.

6. The method of claim 1, wherein grouping a physical resource block comprises:
interleaving the physical resource block; and
grouping the interleaved physical resource block in a physical resource block index according to a predetermined group size.

7. A method for receiving a control channel resource of a user equipment, the method comprising:
receiving group information of a physical resource block to which the control channel resource is mapped through upper signaling;
receiving a physical resource block index to be used by the user equipment from a group allotted according to the received group information; and
demodulating scheduling information from a control channel resource corresponding to the physical resource block index.

8. The method of claim 7, wherein demodulating scheduling information comprises;
receiving entire control channel resources corresponding to the physical resource block index; and
receiving a control channel resource allotted to the user equipment from the entire control channel resources using a blind demodulator.

9. The method of claim 8, wherein receiving a control channel comprises:
demodulating the entire control channel resources through a cyclic shift, a deinterleaver and a scrambler; and
confirming the control channel resource allotted to the user equipment through blind demodulation from the demodulated control channel resource.

10. A mobile communication system for grouping a control channel resource, the system comprising:
a base station for grouping a physical resource block to which a control channel resource will be mapped in a data channel region to determine a group to be used by a user equipment from groups of the physical resource block, transmitting information about the group to the user equipment through upper signaling, mapping the control channel resource to the group, and transmitting the mapped result to the user equipment; and
the user equipment for receiving a physical resource block index to be used by the user equipment from a group allotted according to group information of the physical resource block to which the control channel is mapped when the group information is received through upper signaling, and demodulating scheduling information from the control channel resource corresponding to the physical resource block index.

11. The mobile communication system of claim 10, wherein the base station interleaves the physical resource block, cyclically shifts the interleaved physical resource block by a cell ID, and groups the cyclically shifted physical resource block in a physical resource block index order according to a predetermined group size.

12. The mobile communication system of claim 11, wherein the base station cyclically shifts the physical resource block using a physical identity (N_{ID}⁽²⁾) being an ID allotted to a small cell among elements constituting the cell ID.

13. The mobile communication system of claim 11, wherein the base station transmits resource group information to be used by the base station to a neighboring cell when coordination is necessary between cells.

14. The mobile communication system of claim 11, wherein the base station transmits resource group information to be used by the base station to a neighboring cell when coordination is necessary between base stations.

15. The mobile communication system of claim 11, wherein the base station interleaves the physical resource block and groups the interleaved physical resource block in a physical resource block index order according to a predetermined group size.

16. The mobile communication system of claim 11, wherein the user equipment receives a control channel resource allotted to the user equipment using a blind demodulator among entire control channel resources included in the physical resource block index when the entire control channel resources are received.

17. The mobile communication system of claim 16, wherein the user equipment demodulates the entire control channel resources through a cyclic shift, a deinterleaver, and a scrambler, and confirms a control channel resource allotted to the user equipment through blind demodulation in the demodulated entire control channel resources.
